(19) United States
(12) Patent Application Publication
(10) Pub. No.: US 2013/0183179 A1
(43) Pub. Date: Jul. 18, 2013

(54) MOTOR AND ELECTRIC PUMP

(71) Applicant: Aisan Kogyo Kabushiki Kaisha, Aichi-ken (JP)

(72) Inventor: Atsushi Sugimoto, Obu-shi (JP)

(73) Assignee: AISAN KOGYO KABUSHIKI KAISHA, Aichi-ken (JP)

(21) Appl. No.: 13/741,262

(22) Filed: Jan. 14, 2013

(30) Foreign Application Priority Data
Jan. 16, 2012 (JP) 2012-006478

(51) Int. Cl. H02K 1/18

(52) U.S. Cl. CPC H02K 1/185
USPC 417/423.7; 310/216.009

(57) ABSTRACT

A motor may comprise a rotor and a stator. A first core of the stator may comprise three pieces of first partial cores and a first connecting portion connecting the first partial cores adjacent to one another. The first partial core may comprise a tooth part disposed at a front edge portion and a contacting part disposed at a rear edge portion. The contacting part may contact the adjacent first partial core. The first core may be formed such that a state of the contacting parts changes from a separated state in which the contacting parts are separated from each other to a contacting state in which the contacting parts of the adjacent first partial cores are contacting each other.

### CROSS-REFERENCE TO RELATED APPLICATIONS

This application claims priorities to Japanese Patent Application No. 2012-006478, filed on Jan. 16, 2012, the contents of which are hereby incorporated by reference into the present application.

### TECHNICAL FIELD

The present application discloses a motor and an electric pump.

### DESCRIPTION OF RELATED ART

Japanese Patent Application Publication No. 2003-189570 discloses a motor that includes a rotator and a stator. The stator includes a :ring-shaped portion and six pieces of projecting portions (i.e., tooth parts). The ring-shaped portion surrounds the rotator (i.e., rotor). Three pieces of first projecting portions among the six pieces of projecting portions protrude in the same direction from an outer circumference of the ring-shaped portion. Three pieces of second projecting portions among the six pieces of projecting portions protrude from the outer circumference of the ring-shaped portion in a direction opposite to the protruding direction of the first projecting portions. A bobbin around which a coil wire is wound is fitted to each projecting portion. The three pieces of first projecting portions are connected by a connecting portion at an edge on a side opposite to the ring-shaped portion. An insertion portion formed in each of the first projecting portions is fitted to a fitting hole formed in the connecting portion. The three pieces of second projecting portions have the same configuration as the first projecting portions.

### SUMMARY

In the above-described motor, the connecting portion that connects the projecting portions (i.e., tooth parts) is provided as a member that is separated from the projecting portions. This is because after the coil wire is wound around the bobbin, the bobbin around which the coil wire is wound is fitted to the projecting portion. In this configuration, it is necessary to strictly control positional accuracy between the insertion portion formed in the projecting portion and the fitting hole formed in the connecting portion. As a result, it is difficult to manufacture the motor easily. In this specification, a motor which may be manufactured relatively easily is provided.

The present application discloses a motor. The motor may comprise a rotor and a stator comprising a first core and a second core opposing the first core across the rotor. The first core may comprise three pieces of first partial cores and a first connecting portion connecting the first partial cores that are adjacent to one another. Each of the first partial cores may comprise a tooth part and a contacting part. The tooth part may be disposed at a front edge portion of the first partial core. The tooth part may extend toward the second core. The front edge of the tooth part may oppose an outer circumference of the rotor with a clearance in between. The contacting part may be disposed at a rear edge portion of the first partial core. The contacting part may be configured to contact the adjacent first partial core. The first connecting portion may connect edge portions of the teeth parts of the adjacent first partial cores included in the three pieces of the first partial cores. In view of the stator along a rotation axis of the rotor, a thickness of the first connecting portion may be thinner than a thickness of the first partial cores. The first core may be formed such that a state of the contacting parts of the adjacent first partial cores changes from a separated state in which the contacting parts of the adjacent first partial cores are separated from each other to a contacting state in which the contacting parts of the adjacent first partial cores are contacting each other by a deformation of the first connecting portion.

In this configuration, the contacting parts of the adjacent first partial cores are separated from each other before the first connecting portion is deformed. Thus, a device for winding a coil wire may be inserted between the adjacent two pieces of first partial cores. Thus, the coil wire may be winded around the bobbin after the bobbin is disposed in the tooth part. For example, the coil wire may be winded after a bobbin made from a resin is formed in the tooth part. According to this configuration, it is not necessary to take the arrangement of the bobbin around which the coil wire is wound into consideration, and the connecting portion for connecting the adjacent first partial cores may be provided to be integral with the first partial cores. Therefore, the motor may be manufactured relatively easily.

The present application discloses an electric pump. The electric pump may comprise the above motor, an impeller configured to activate by the motor and a pump chamber configured to contain the impeller rotatably.

According to this configuration, an electric pump may be manufactured relatively easily.

### BRIEF DESCRIPTION OF DRAWINGS

FIG. 1 shows a schematic longitudinal cross-sectional view of an electric pump.

FIG. 2 shows a stator according to a first embodiment when seen from the upper side of FIG. 1.

FIG. 3 shows intermediate components for manufacturing the stator according to the first embodiment when seen from the upper side of FIG 1.

FIG. 4 shows a stator according to a second embodiment when seen from the upper side of FIG. 1.

FIG. 5 shows a view for explaining a core plate of the stator according to the second embodiment.

FIG. 6 shows intermediate components for manufacturing the stator according to the second embodiment when seen from the upper side of FIG. 1.

FIG. 7 shows a core plate according to a third embodiment when seen from the upper side of FIG. 1.

FIG. 8 shows an original plate according to the third embodiment when stem from the upper side of FIG. 1.

FIG. 9 shows the core plate according to the third embodiment when seen from the upper side of FIG. 1.

FIG. 10 shows the original plate according to the third embodiment when seen from the upper side of FIG. 1.

FIG. 11 shows a view for explaining a method of manufacturing a stator according to a modification,

### DETAILED DESCRIPTION

Some features of the sensor device disclosed herein will be described. The first core may comprise a plurality of core plates layered in a direction of rotation of the rotor. The plurality of core plates includes a first core plate with a first form and a second core plate with a second form that is different from the first form. The first core plate may comprise three pieces of first partial core plates configuring the three pieces of first partial cores. The second core plate comprises three pieces of second partial core plates configuring the three pieces of first partial cores. In view of the stator along the rotation axis of the rotor, a form of a first center partial core plate located at a center among the three pieces of first partial core plates is different from a form of a second center partial core plate located at a center among the three pieces of second partial core plates. In a state in which the first core plate is layered with the second core plate, a surface on one side of the first center partial core plate contacts surfaces on one side of the three pieces of second partial core plates.

For example, when the dimensional accuracy of the first core plate is not so high, there is a possibility that the respective pieces of first partial core plates are not appropriately in contact with each other. If the first core includes core plates with the same form only, there is a possibility that three pieces of first partial cores are not appropriately in contact with each other. According to the configuration of the above feature, the first center partial core plate makes surface-contact with two pieces of second partial core plates among the three pieces of second partial core plates other than the second center partial core plate. Thus, even when the first partial core plates are not appropriately in contact with each other, the three pieces of first partial cores may be appropriately contacted with each other by the second partial core plates. According to this configuration, it is not necessary to strictly control the dimensional accuracy of the core plate.

The three pieces of first partial cores may comprise a first center partial core and two pieces of first side partial cores. Each of the first side partial cores may be adjacent to the first center partial core. Each of the first side partial cores may comprise a yoke part and a connecting part. The yoke part may be configured to contact a rear edge of the tooth part of the first side partial core and extend toward a rear edge of the first center partial core. The connecting part may be configured to connect the tooth part and the yoke part. In view of the stator along the rotation axis of the rotor, a thickness of the connecting parts may be thinner than a thickness of the yoke parts and a thickness of the tooth parts. Each of the first side partial cores may be fanned such that a state of the yoke part and the tooth part changes from a state in which the yoke part and the tooth part are disposed on a same straight line to a state in which the yoke part and the tooth part contact each other by a deformation of the connecting part.

In this configuration, the first side partial cores may he manufactured by manufacturing an intermediate component in which the yoke part and the tooth part are arrayed on the same straight line and then deforming the connecting portion. According to this configuration, the straight line on which the yoke part and the tooth part are arrayed may be closely disposed on a magnetization direction of a metal material. As a result, a magnetic resistance of the first partial core may be decreased.

The first core may comprise a plurality of core plates layered in a direction of rotation of the rotor. The plurality of core plates may include a third core plate with a third form and a core plate with a fourth in that is different from the third form. The third core plate may comprise three pieces of third partial core plates configuring the three pieces of first partial cores. The fourth core plate may comprise three pieces of fourth partial core plates configuring the three pieces of first partial cores. In view of the stator along the rotation axis of the rotor, in the third partial core plate and the fourth partial core plate configuring the same first side partial core, a contact, position between a partial plate configuring the yoke part and a partial plate configuring the tooth part of the third partial core plate may be different from a contact position between a partial plate configuring the yoke part and a partial plate configuring the tooth part of the fourth partial core plate.

For example, when the dimensional accuracy of the core plate with the third form is not so high, there is a possibility that constituent portions of the yoke parts of the respective pieces of third partial core plates and constituent portions of the tooth parts thereof are not appropriately in contact with each other. If the first core includes core plates with the third form only, there is a possibility that the yoke part and the tooth part of the side partial core are not appropriately in contact with each other. On the other hand, according to the above configuration, the constituent portions of the yoke part of the third partial core plate may make surface-contact with the constituent portions of the tooth part of the fourth partial core plate, or the constituent portions of the tooth part of the third partial core plate may make surface-contact with the constituent portions of the yoke part of the fourth partial core plate. Thus, even when the constituent portions of the yoke part of the third partial core plate is not appropriately in contact with the constituent portions of the tooth part, the yoke part and the tooth part may be appropriately contacted with each other by the fourth partial core plate. Therefore, it is not necessary to strictly control the dimensional accuracy of the core plate.

The three pieces of first partial cores may comprise a first center partial core and two pieces of first side partial cores. Each of the first side partial cores may adjacent to the first center partial core. The second core may comprise three pieces of second partial cores. The three pieces of second partial cores may comprise a second center partial core and two pieces of second side partial cores. Each of the second side partial cores may be adjacent to the second center partial core. Each of the second side partial cores may be opposed to the each of first side partial cores. The stator may further comprise a second connecting portion connecting one of, or both of the two pieces of first side partial cores of the first core and the corresponding second side partial core of the second core opposing the first side partial core connected to the second connecting portion. In view of the stator along the rotation axis of the rotor, a thickness of the second competing portion may be thinner than a thickness of the first partial cores and a thickness of the second partial cores.

According to this configuration, the first core may integrate with the second core. Moreover, the second connecting portion may be deformed so as to follow a deformation of the first connecting portion. As a result, a motor may he manufactured relatively easily.

A contacting part of each of the first partial cores may contact with other two pieces of the first partial cores.

In this configuration, in a case where a magnetic flux flows from one partial core of the three pieces of partial cores into another partial core, one partial core boundary (i.e., a portion in which the adjacent partial cores contact with each other) is positioned on the path of the magnetic flux. As a result, a magnetic resistance may be decreased as compared to a case where a plurality of boundaries of partial cores is positioned on the path of the magnetic flux.

The first core and the second core may have a symmetrical form.

According to this configuration, the second core may be formed easily in the same manner as the first core. Thus, a motor may be manufactured relatively easily.

Representative, non-limiting examples of the present invention will now be described in further detail with reference to the attached drawings. This detailed description is merely intended to teach a person of skill in the art further details for practicing preferred aspects of the present teachings and is not intended to limit the scope of the invention. Furthermore, each of the additional features and teachings disclosed below may be utilized separately or in conjunction with other features and teachings to provide improved motor and electric pump.

Moreover, combinations of features and steps disclosed in the following detailed description may not be necessary to practice the invention in the broadest sense, and are instead taught merely to particularly describe representative examples of the invention. Furthermore, various features of the above-described and below-described representative examples, as well as the various independent and dependent claims, may be combined in ways that are not specifically and explicitly enumerated in order to provide additional useful embodiments of the present teachings.

All features disclosed in the description anchor the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### First Embodiment

(Configuration of Electric Pump 10)

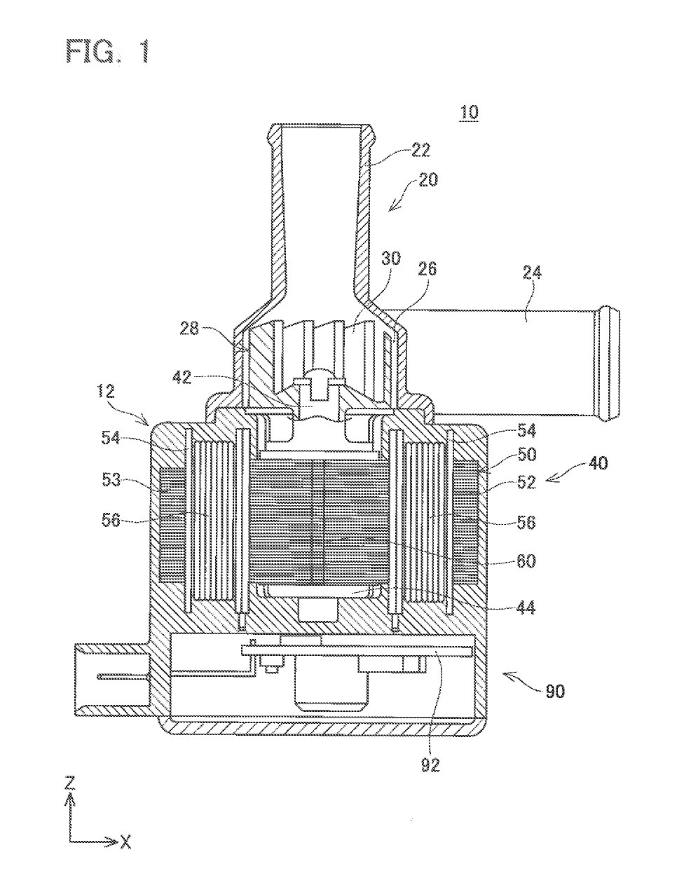

An electric pump 10 is provided in an engine room of an automobile and used for circulating cooling water that cools down an engine, an inverter, and the like. As shown in FIG. 1, the electric pump 10 comprises a pump portion 20, a motor portion 40, and a circuit portion 90.

The pump portion 20 is formed in an upper portion of a casing 12. The pump portion 20 includes a pump chamber 26. An intake port 22 and a discharge port 24 formed in the casing 12 are connected to the pump chamber 26. The intake port 22 is connected to an upper edge of the pump chamber 26. The intake port 22 extends in an extension direction of a rotation axis of a rotating body 28. The discharge port 24 is connected to an outer circumference of the pump chamber 26. The discharge port 24 extends in a tangential direction of the outer circumference of the pump chamber 26. An impeller 30 of the rotating body 28 is disposed in the pump chamber 26.

The motor portion 40 is disposed below the pump portion 20. The motor portion 40 configures a brushless motor. The motor portion 40 comprises a fixed shaft 42, a rotor 44, and a stator 50. The lower edge of the fixed shaft 42 is fixed to the casing 12. The fixed shaft 42 extends in the vertical direction inside the easing 12 and an upper edge thereof reaches the inside of the pump chamber 26. The rotating body 28 is rotatably attached to the fixed shaft 42. The stating body 28 comprises the impeller 30 and the rotor 44. A plurality of blades is formed at a predetermined interval on an upper surface of the impeller 30. The rotor 44 having a cylindrical shape is formed below the impeller 30. The rotor 44 is formed from a magnetic material and is magnetized so as to have a plurality of magnetic poles in a circumferential direction. The impeller 30 and the rotor 44 are integrally connected. Thus, when the rotor 44 rotates, the impeller 30 also rotates. The stator 50 is disposed on an outer circumference side of the rotor 44 and opposes the rotor 44. A detailed configuration of the stator 50 will be described later.

The circuit portion 90 is disposed below the motor portion 40. A control circuit 92 that controls supply of electric power to the stator 50 is disposed in the circuit portion 90. The control circuit 92 is connected to an external power supply (e.g., a battery mounted on a vehicle) (not shown) by wires (not shown). The control circuit 92 supplies the electric power supplied from the external power supply to the motor portion 40.

(Configuration of Stator 50)

Next, the stator 50 will be described in detail. The stator 50 comprises two cores 52 and 53. The two cores 52 and 53 are covered by a resin layer 14 that constitutes the casing 12. The two cores 52 and 53 are disposed bilaterally symmetrical with the rotor 44 interposed. Each of the two cores 52 and 53 comprises a plurality of core plates. The core plate is formed of a magnetic steel plate. All of the plurality of core plates has the same shape.

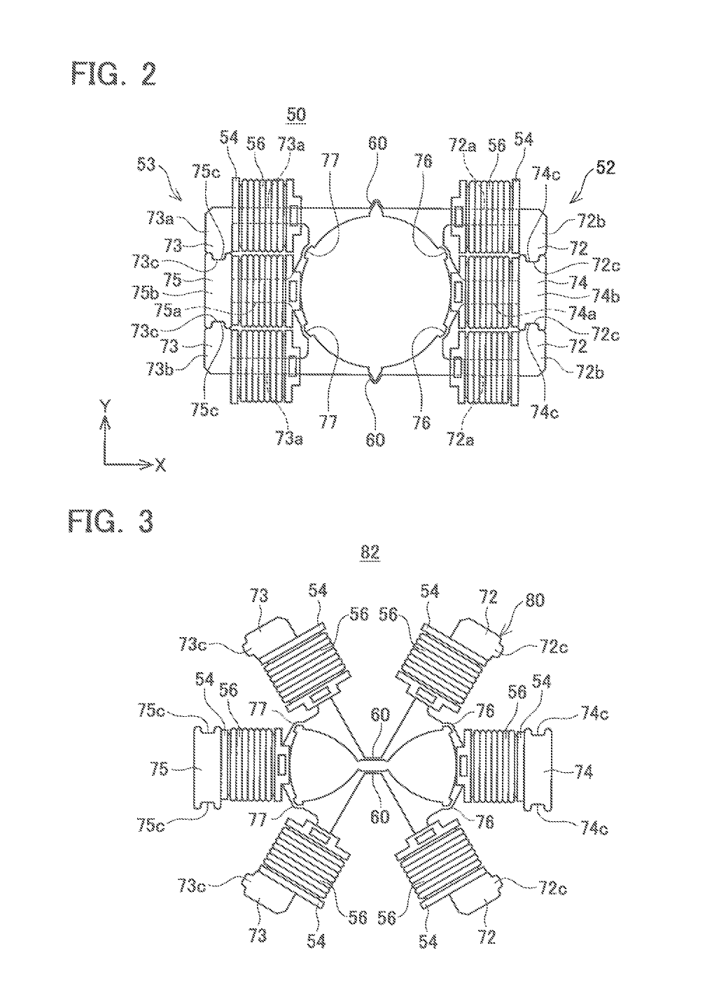

As shown in FIG. 2, the core 52 comprises three pieces of partial cores 72, 74, 72 that are arrayed in the Y-direction. The core 53 comprises three pieces of partial cores 73, 75, 73 that are arrayed in the Y-direction. The core 53 has the same configuration as the core 52 except that the cores 52 and 53 are disposed bilaterally symmetrical about the rotor 44. Thus, in the following description, the core 52 will be described as a representative example.

The three pieces of partial cores 72, 74, 72 comprise two pieces of side partial cores 72 positioned on both sides in the V-direction of the core 52 and a central partial core 74 positioned between the two pieces of side partial cores 72. The two pieces of side partial cores 72 are disposed symmetrical with the central partial core 74 interposed.

The central partial core 74 comprises a tooth part 74a and a yoke part 74b. The yoke part 74b is positioned at a rear edge (i.e., an edge on a side opposite to the rotor 44) of the central partial core 74. The yoke part 74b extends in the Y-direction. A contacting surface 74c is formed at each of both edges in the Y-direction of the yoke part 74b. The tooth part 74a extends toward the core 53 (i.e., in the X-direction) from the center of the yoke part 74b in the Y-direction. A bobbin 54 around which a coil wire 56 is wound is attached to an intermediate position of the tooth part 74a. A width (i.e., Y-direction length) of a range of the tooth part 74a to which the bobbin 54 is attached is smaller than a width (i.e., Y-direction length) of the yoke part 74b.

A front edge (i.e., an edge on a side closer to the rotor 44) of the tooth part 74a is formed in a shape that follows an outer circumferential surface of the rotor 44. The front edge of the tooth part 74a is disposed with a clearance from the outer circumferential surface of the rotor 44. A connecting portion 76 that connects the central partial core 74 and each of the two pieces of side partial cores 72 is formed at the front edge of the tooth part 74a. When the stator 50 is seen from an extension line (i.e., the upper side of FIG. 1) of the rotation axis of the rotor 44, the connecting portion 76 is formed to have a thickness that is smaller than a thickness of any of the three pieces of partial cores 72, 74, 72.

Each side partial core 72 comprises a tooth part 72a and a yoke part 72b. The yoke part 72b is positioned at a rear edge (i.e., an edge on a side opposite to the rotor 44 (on a side turned away from the rotor)) of the side partial core 72. The yoke part 72b extends toward the yoke part 74b and has a contacting surface 72c that contacts a contacting surface 74c of the yoke part 74b. The tooth part 72a is positioned at an edge of the yoke part 72b on a side opposite to the central partial core 74 (he., turned away from the central partial core 74). The tooth part 72a extends toward the core 53 (i.e., in the X-direction). The bobbin 54 around which the coil wire 56 is wound is attached to an intermediate position of the tooth part 72a. A width (i.e., Y-direction length) of a range of the tooth part 72a to which the bobbin 54 is attached is smaller than a width of the yoke part 72b.

A front edge (i.e., an edge on a side closer to the rotor 44) of the tooth part 72a is formed in a shape that follows the outer circumferential surface of the rotor 44. The front edge of the tooth part 72a is disposed with a clearance from the outer circumferential surface of the rotor 44. The front edge of the tooth part 72a is connected to the front edge of the tooth part 74a by the connecting portion 76.

The core 53 comprises partial cores 73 (73a to 73c) and 75 (75a to 75c) and a connecting portion 77 similar to the partial cores 72 (72a to 72c) and 74 (74a to 74c) and the connecting portion 76 of the core 52. That is, the central partial core 75 and the side partial cores 73 are connected by the connecting portion 77. Moreover, a contacting surface 75c of the central partial core 75 is in contact with the contacting surface 73c of each of the side partial cores 73.

The two cores 52 and 53 are connected by connecting portions 60. More specifically, each side partial core 72 faces one side partial core 73 in the X-direction. The connecting portion 60 is connected to each of the front edges of the pair of opposing side partial cores 72 and 73. In other words, the pair of opposing side partial cores 72 and 73 is connected by the connecting portion 60 formed at each of the front edges thereof. When the stator 50 is seen from an extension line (i.e., the upper side of FIG I) of the rotation axis of the rotor 44, the connecting portion 60 is formed in a V-shape.

Next, a method of manufacturing the motor portion 40 will be described. First, a method of manufacturing the stator 50 will be described. As shown in FIG. 3, first, a plurality of original plates 80 for manufacturing a plurality of core plates is manufactured. The original plates 80 are formed by punching a magnetic steel plate. Subsequently, the plurality of original plates 80 is layered. As a result, six pieces of partial cores 72 to 75 are formed. In this step, the central partial core 74 and the respective side partial cores 72 are connected by the connecting portions 76. On the other hand, the contacting surface 72c and the contacting surface 74c are separated from each other. The relationship between the central partial core 75 and the respective side partial cores 73 is the same as the relationship between the central partial core 74 and the respective side partial cores 72.

Subsequently, the bobbin 54 is attached to the tooth parts 72a to 75a of the respective partial cores 72 to 75. Specifically, the bobbin 54 made from a resin is formed according to insert molding. Subsequently, the coil wire 56 is wound around each bobbin 54. Whereby an intermediate component 82 is manufactured. In the intermediate component 82, the respective partial cores 72 to 75 are disposed so as to extend approximately in a radial form. Thus, a gap between the side partial core 72 and the central partial core 74 and a gap between the side partial core 73 and the central partial core 75 are larger than that of the stator 50. In this configuration, first, the bobbin 54 is formed in the respective partial cores 72, to 75, and subsequently, the coil wire 56 can be wound around the bobbin 54. This is because a device for winding the coil wire 56 can be inserted between the partial cores.

When winding of the coil wires 56 is completed, each side partial 72 is rotated with the central position of the connecting portion 76 as a center. As a result, each side partial core 72 is moved relative to the central partial core 74, and the contacting surface 72c contacts the contacting surface 74c. At the same time, each side partial core 73 is rotated with the central position of the connecting portion 77 as a center. As a result, each side partial core 73 is moved relative to the central partial core 75, and the contacting surface 73c contacts the contacting surface 75c. In this case, due to the rotation of the side partial cores 72 and the side partial cores 73, a bending deformation is applied to the connecting portions 60, 76, 77. As a result, the stator 50 shown in FIG. 2 is manufactured.

Subsequently, the resin layer 14 is formed according to insert molding that uses the stator 50 and the fixed shaft 42. The rotor 44 (i.e., the rotating body 28) is attached to the fixed shaft 42 that is fixed to the resin layer 14 according to the insert molding, whereby the motor portion 40 is manufactured.

(Operation of Electric Pump 10)

Next, the operation of the electric pump 10 will be described. When electric power is applied from the control circuit 92 to the coil wire 56, the rotor 44 rotates around the fixed shaft 42. As a result, the impeller 30 rotates, and cooling water is sucked into the pump chamber 26 from the intake port 22. The cooling water sucked into the pump chamber 26 is pressurized according to the rotation of the impeller 30 and is discharged outside the casing 12 from the discharge port 24.

As shown in FIG. 3, in the state of the intermediate component 82, the contacting surface 74c and the contacting surface 72c are separated from each other. Thus, the gap between the respective partial cores 72 and 74 is relatively large. As a result, a device for winding the coil wire 56 can be inserted between the central partial core 74 and the side partial core 72. That is the coil wire 56 can be wound around the bobbin 54 after the bobbin 54 is disposed in the tooth parts 72a and 74a. As a result, it is possible to form the bobbin 54 according to insert molding. Thus, in a case where the bobbins 54 are disposed in the tooth parts 72a and 74a, the yoke parts 72b and 74b do not become an obstacle. In this configuration, it is not necessary to take the arrangement in the tooth parts 72a and 74a, of the bobbins 54 around which the coil wires 56 are wound into consideration. According to this configuration, it is possible to provide the tooth parts 72a and 74a to be integrated with the yoke parts 72b and 74b. As a result, it is possible to manufacture the motor portion 40 relatively easily. The same is true for the core 53.

The cores 52 and 53 are connected by the connecting portions 60. ‘Thus, it is possible to integrate the cores 52 and 53 with each other.

The Thickness of the connecting portions 60, 76, 77 is smaller than the thickness of the respective partial cores 72 to 75. That is, in the intermediate component 82, the connecting portions 60, 76, 77 have a rigidity that is lower than that of the respective partial cores 72 to 75. Thus, when the stator 50 is manufactured by deforming the connecting portions 60, 76, 77, it is possible to suppress a deformation of the respective partial cores 72 to 75.

The connecting portions 60, 76, 77 are work-hardened by bending deformation during manufacturing. When a metallographic structure of the connecting portions 60, 76, 77 is observed, a metallographic structure after application of bending deformation is observed.

Since the electric pump 10 comprises the motor portion 40, it is possible to manufacture the electric pump 10 relatively easily,

### Second Embodiment

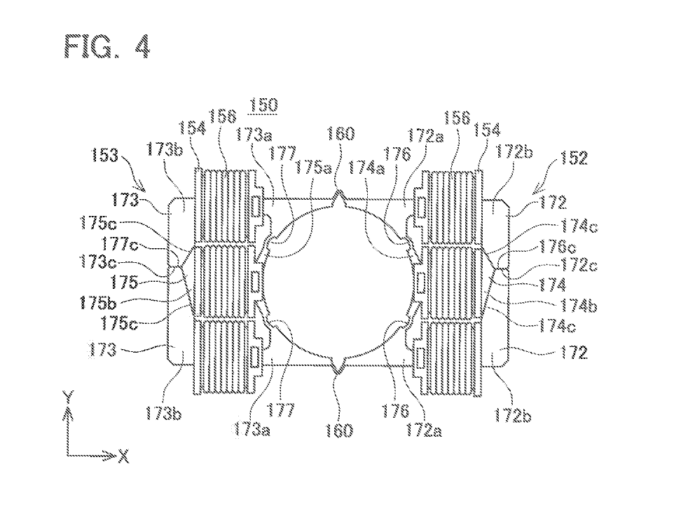

Differences from the first embodiment will be described mainly. The motor portion 40 comprises a stator 150 instead of the stator 50. As shown in FIG. 4, in the second embodiment, the shape of each of partial cores 172 to 175 provided in two cores 152 and 153 of the stator 150 is different from the shape of each of the partial cores 72 to 75 provided in the two cores 52 and 53. More specifically, the shape of each of yoke parts 172b to 175b of the respective partial cores 172 to 175 is different from the shape of each of the yoke parts 72b to 75b of the respective partial cores 72 to 75.

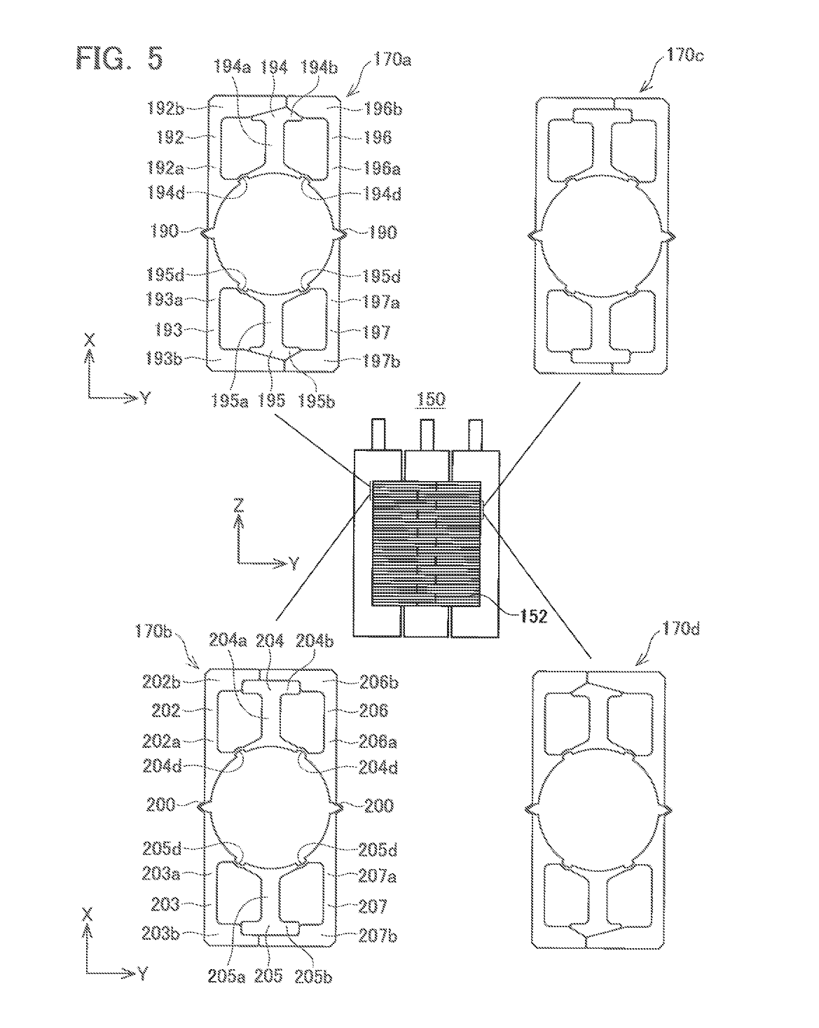

The partial cores 172 to 175 have tooth parts 172a to 175a and yoke parts 172b to 175b. A bobbin 154 around which a coil wire 156 is wound is attached to each of the tooth parts 172a to 175a. As shown in FIG. 5, the stator 150 comprises four types of core plates 170a to 170d, In FIG. 5, the size of the stator 150 is depicted to be smaller than the core plates 170a to 170d. In the stator 150, the types of core plates are changed in the respective three layers from top to down in the Z-direction. The core plates 170a to 170d have the same outer shape.

The core plate 170a comprises six pieces of partial core plates 192 to 197, four pieces of partial connecting portions 194d to 195d, and two pieces of partial connecting portions 190. A center partial core plate 194 constitutes a portion (corresponding to one layer) of the central partial core 174. The center partial core plate 194 comprises a tooth plate 194a that constitutes a portion (corresponding to one layer) of the tooth part 174a and a yoke plate 194b that constitutes a portion (corresponding to one layer) of the yoke part 174b. Side partial core plates 192 and 196 constitute a set of portions (corresponding to one layer) of the side partial cores 172. The side partial core plates 192 and 196 comprise tooth plates 192a and 196a that constitute a set of portions (corresponding to one layer) of the tooth parts 172a and yoke plates 192b and 196b that constitute a set of portions (corresponding to one layer) of the yoke parts 172b. The partial connecting portion 194d constitutes a portion (corresponding to one layer) of each connecting portion 176.

Similar to the central partial core plate 194, the central partial core plate 195 (195a and 195b) constitutes a portion of the central partial core 175 (175a and 175b). Similar to the side partial core plates 192 and 196, the side partial core plates 193 (193a and 193b) and 197 (197a and 197b) constitute a set of portions of the side partial cores 173 (173a and 173b). The partial connecting portion 195d constitutes a portion (corresponding to one layer) of each connecting portion 177. The partial connecting portion 190 constitutes a portion of each connecting portion 160. In the core plate 170a, since portions that constitute the core 152 and portions that constitute the core 153 are symmetrical, in the following description, the portions that constitute the core 152 will be described as a representative example.

The yoke plate 194b has an approximately triangular shape in a plan view. The tooth plate 194a is connected to the center of the longest side of the yoke plate 194b. Each of two sides of the yoke plate 194b other than the longest side contacts each of the yoke plates 192b and 196b. The side of the yoke plate 194b that contacts the yoke plate 192b is longer than the side of the yoke plate 194b that contacts the yoke plate 196b.

The yoke plate 192b contacts the yoke plate 194b and also contacts the yoke plate 196b. A contact position between the yoke plate 192b and the yoke plate 196b is shifted toward the side partial core plate 196 from the center (i.e., the center in the Y-direction of the core plate 170a) of the center partial core plate 194. In other words, the Y-direction length of the yoke plate 192b is larger than the Y-direction length of the yoke plate 196b, and the yoke plate 192b extends toward the side partial core plate 196 over a central line in the Y-direction of the core plate 170a.

The core plate 170b comprises six pieces of partial core plates 202 to 207, four pieces of partial connecting portions 204d to 205d, and two pieces of partial connecting portions 200. A center partial core plate 204 constitutes a portion (corresponding to one layer) of the central partial core 174. The center partial core plate 204 includes a tooth plate 204a that constitutes a portion (corresponding to one layer) of the tooth part 174a and a yoke plate 204b that constitutes a portion (corresponding to one layer) of the yoke part 174b. Side partial core plates 202 and 206 constitute a set of portions (corresponding to one layer) of the side partial core 172. The side partial core plates 202 and 206 comprise tooth plates 202a and 206a that constitute a set of portions (corresponding to one layer) of the tooth parts 172a and yoke plates 202b and 206b that constitute a set of portions (corresponding to one layer) of the yoke parts 172b. The partial connecting portion 204d constitutes a portion (corresponding to one layer) of each connecting portion 176.

Similar to the central partial core plate 204, the contacting portion 205 (205a and 205b) constitutes a portion of the central partial core 175 (175a and 175b). Similar to the side partial core plates 202 and 206, the side partial core plates 203 (203a and 203b) and 207 (207a and 207 b) constitute a set of portions of the side partial cores 173 (173a and 173b). The partial connecting portion 205d constitutes a portion (corresponding to one layer) of each connecting portion 177. The partial connecting portion 200 constitutes a portion of each connecting portion 160.

When the core plate 170a is compared with the core plate 170b in a plan view, two yoke plates disposed at an overlapping position, that is, the yoke plates 192b and 202b, the yoke plates 194b and 204b, and the yoke plates 196b and 206b have different shapes. Similarly; the yoke plates 193b and 203b, the yoke plates 195b and 205b, and the yoke plates 197b and 207b have different shapes. In the core plate 170b, since portions that constitute the core 152 and portions that constitute the core 153 are symmetrical, in the following description, the portions that constitute the core 152 will be described as a representative example.

The yoke plate 204b has an approximately oblong shape in a plan view. The tooth plate 204a is connected to the center of one long side of the yoke plate 204b. A short side of the yoke plate 204b closer to the side partial core plate 202 and a portion of the other long side contact the yoke plate 202b. A short side of the yoke plate 204b closer to the side partial core plate 206 and a portion of the other long side contact the yoke plate 206b. The length of the range of the other long side of the yoke plate 204b that contacts the yoke plate 206b is larger than the length of the range of the other long side that contacts the yoke plate 202b.

The yoke plate 202b contacts the yoke plate 204b and also contacts the yoke plate 206b. A contact position between the yoke plate 202b and the yoke plate 206b is shifted toward the side partial core plate 202 from the center (i.e., a central line in the Y-direction of the core plate 170b) of the center partial core plate 204. In other words, the Y-direction length of the yoke plate 206b is larger than the Y-direction length of the yoke plate 202b, and the yoke plate 206b extends toward the side partial core plate 202 over the central line in the Y-direction of the core plate 170b.

The core plate 170c and the core plate 170b are in a reverse relationship. The core plate 170d and the core plate 170a are in a reverse relationship.

The Y-direction length (i.e., the long-side length) of the yoke plate 204b is larger than the Y-direction length of the yoke plate 194b. On the other hand, the X-direction length (i.e., the short-side length) of the yoke plate 204b is approximately the same as the X-direction length of the yoke plate 194b. From this relationship, in portions where the core plate 170a is in contact with the core plate 170b, the yoke plate 204b makes surface-contact with the yoke plate 194b and also makes surface-contact with the yoke plates 192b and 196b. Moreover, the yoke plate 206b makes surface-contact with the yoke plate 196b and also makes surface-contact with the yoke plate 192b. If the dimensional accuracy of the core plate 170a is not so high, there is a possibility that the respective yoke plates 192b to 196b are not appropriately in contact with each other. In this ease, the yoke plates 192b to 196b are appropriately connected by the yoke plates 204b and 206b. As a result, the three pieces of partial core plates 192 to 196 and the three pieces of partial core plates 202 to 206 can appropriately make contact with each other. Similarly, the three pieces of partial core plates 193 to 197 and the three pieces of partial core plates 203 to 207 can appropriately make contact with each other.

In portions where the core plate 170c is in contact with the core plate 170d, similar to the above, the three pieces of partial core plates of the core plate 170c and the three pieces of partial core plates of the core plate 170d can appropriately make contact with each other. According to this configuration, even when the dimensional accuracy of the core plates 170a to 170d is not controlled strictly, it is possible to allow the three pieces of partial cores 152, 154, and 152 to appropriately make contact with the three pieces of partial cores 153, 155, and 153.

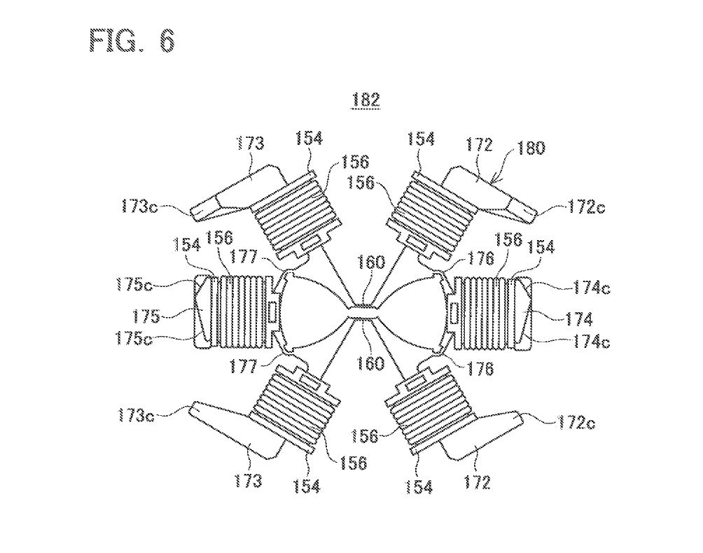

Next, a method of manufacturing the stator 150 will be described. As shown in FIG. 6, first, a plurality of original plates (in FIG. 6, an original plate 180 of the core plate 170a is illustrated) for manufacturing a plurality of core plates is manufactured. The original plate 180 and the like arc formed by punching a magnetic steel plate. Subsequently, a plurality of types of original plates 180 and the like are layered in a predetermined order. As a result, six pieces of partial cores 172 to 175 are formed. In this step, the central partial core 174 and the respective side partial cores 172 are connected by the connecting portions 176. On the other hand, the contacting part 172c and the contacting part 174c are separated from each other. The relationship between the central partial core 175 and the respective side partial cores 173 is the same as the relationship between the central partial core 174 and the respective side partial cores 172.

Subsequently, the bobbins 154 are attached to the respective partial cores 172 to 175 according to insert molding. Subsequently, the coil wire 156 is wound around each bobbin 154, whereby an intermediate component 182 is manufactured. In the intermediate component 182, similar to the intermediate component 82, first, the bobbins 154 are formed in the respective partial cores 172 to 175, and subsequently, the coil wire 156 can be wound around each bobbin 154.

Subsequently, each side partial core 172 is rotated with the central position of the connecting portion 176 as a center. As a result, each side partial core 172 is moved relative to the central partial core 174, and the contacting part 172c contacts the contacting part 174c. At the same time, each side partial core 173 is rotated with the central position of the connecting portion 177 as a center. As a result, each side partial core 173 is moved relative to the central partial core 175, and the contacting part 173c contacts the contacting part 175c. In this case, due to the rotation of the side partial cores 172 and the side partial cores 173, a bending deformation is applied to the connecting portions 160, 176, 177. As a result, the stator 150 shown in FIG. 4 is manufactured. In the core plates 170a to 170d, the partial yoke plates 192b and the like that constitute the yoke part 172b have different shapes. Thus, the contacting parts 172c have uneven shapes. The same is true for the contacting parts 174c to 177c.

When the motor portion 40 that comprises the stator 150 is used, a magnetic flux flows between the two pieces of partial cores among the three pieces of partial cores 152, 154, 152 and the two pieces of partial cores among the three pieces of partial cores 153, 155, 153. The three pieces of partial cores 152, 154, 152 are in contact with each other. Similarly, the three pieces of partial cores 153, 155, 153 are in contact with each other. Thus, the magnetic flux flowing between the two pieces of partial cores passes through one boundary between the partial cores. According to this configuration, it is possible to decrease a magnetic resistance as compared to a case where the magnetic flux flowing between two pieces of partial cores passes through at least two boundaries between partial cores.

Moreover, the motor portion 40 that comprises the stator 150 according to the second embodiment can provide the same advantages as those of the motor portion 40 that comprises the stator 50 according to the first embodiment.

### Third Embodiment

Differences from the second embodiment will be described. The motor portion 40 according to the third embodiment comprises a stator that comprises two types of core plates 270 and 370 instead of the core plates 170a to 170d. Since the outer shape of the stator that is manufactured by layering of the core plates 270 and 370 is the same as the outer shape of the stator 150 shown in FIG. 4, a stator manufactured according to the third embodiment will be referred to as a stator 150. The outer shape of the core plates 270 and 370 is the same as the outer shape of the core plates 170a to 170d.

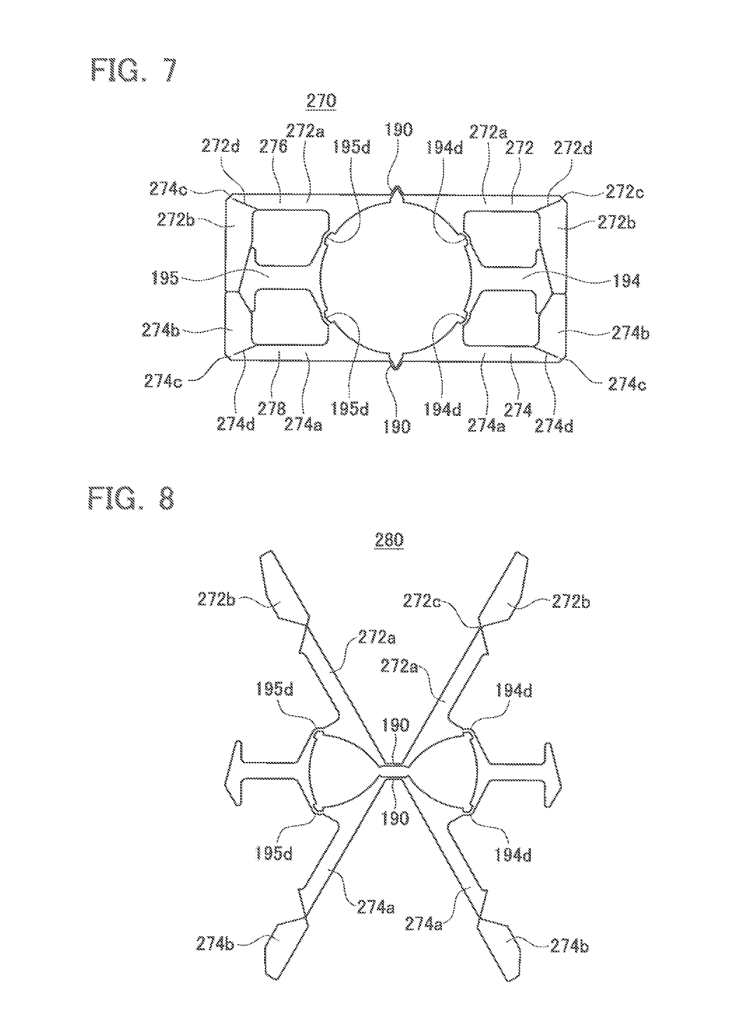

As shown in FIG. 7, the core plate 270 comprises side partial core plates 272, 274, 276, 278 Which have a configuration that is different from the configuration of the side partial core plates 192, 193, 196, 197 as compared to the core plate 170a. The other configuration of the core plate 270a is the same as the configuration of the core plate 170a. The outer shape of the side partial core plates 272, 274, 276, 278 is the same s the outer shape of the side partial core plates 192, 193, 196, 197. Moreover, the side partial core plate 272 and the side partial core plate 276 have the same outer shape and the same configuration except that the side partial core plates are bilaterally symmetrical. Further, the side partial core plate 274 and the side partial core plate 278 have the same outer shape and the same configuration except that the side partial core plates are bilaterally symmetrical. In the following description, the side partial core plates 272 and 274 will be described only. In the respective side partial core plates 276 and 278, the same portions as the respective portions 272a to 274b of the side partial core plates 272 and 274 will he denoted by the same reference numerals.

The side partial core plate 272 comprises a tooth plate 272a that constitutes a portion (corresponding to one layer) of the tooth part 172a and a yoke plate 272b that constitutes a portion (corresponding to one layer) of the yoke part 172b. The tooth plate 272a and the yoke plate 272b are connected by a connecting portion 272c. The tooth plate 272a and the yoke plate 272b are in contact with each other at a contact position 272d.

The side partial core plate 274 comprises a tooth plate 274a that constitutes a portion (corresponding to one layer) of the tooth part 172a and a yoke plate 274b that constitutes a portion (corresponding to one layer) of the yoke part 172b. The tooth plate 274a and the yoke plate 274b are connected by a connecting portion 274c. The tooth plate 274a and the yoke plate 274b are in contact with each other at a contact position 274d.

As shown in FIG. 8, in an original plate 280 before the core plate 270 is manufactured, the tooth plate 272a and the yoke plate 272b are disposed linearly. Similarly, the tooth plate 274a and the yoke plate 274b are disposed linearly. According to this configuration, the tooth plates 272a and 274a and the yoke plates 272b and 274b can be closely disposed to each other in a direction where a magnetic steel plate is easily magnetized. For example, the original plate 280 can be formed from the magnetic steel plate so that the direction where the magnetic steel plate is easily magnetized is parallel to the up-down direction of FIG. 8. In this case, the contacting portions 194 and 195 are disposed in a direction vertical to the direction where the magnetic steel plate is easily magnetized. The side partial core plates 272 and the like are longer than the contacting portions 194 and 195. According to this configuration, it is possible to decrease a difference in magnetic resistance due to a difference in the shape of the partial core plate 194 and the like.

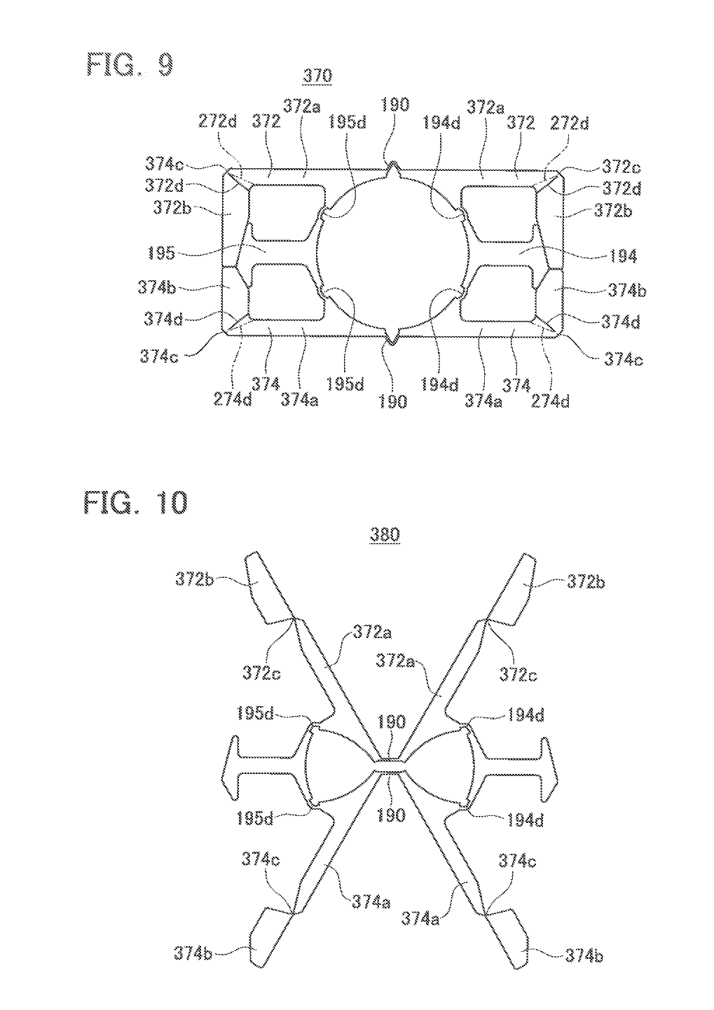

As shown in FIG. 9, the core plate 370 is different from the core plate 270 in that the shapes of a tooth plate 372a and a yoke plate 372b of the partial core plate 372 are different from the shapes of the tooth plate 272a and the yoke plate 272b. Thus, a contact position 372d between the tooth plate 372a and the yoke plate 372b is different from the contact position 272d. Similarly, the shapes of a tooth plate 374a and a yoke plate 374b of the partial core plate 374 are different from the shapes of the tooth plate 274a and the yoke plate 274b. Thus, a contact position 374d between the tooth plate 374a and the yoke plate 374b is different from the contact position 274d. The other configuration of the core plate 370 is the same as the configuration of the core plate 270.

As shown in FIG. 10, in an original plate 380 before the core plate 370 is manufactured, the tooth plate 372a and the yoke plate 372b are disposed linearly in a state where the tooth plate 372a and the yoke plate 372b are connected by the connecting portion 372c. Similarly, the tooth plate 374a and the yoke plate 374b are disposed linearly in a state where the tooth plate 374a and the yoke plate 374b are connected by the connecting portion 374c. According to this configuration, the tooth plates 372a and 374a and the yoke plates 372b and 374b can be closely disposed in a direction where the magnetic steel plate is easily magnetized. According to this configuration, it is possible to decrease a difference in magnetic resistance due to a difference in the shape of the partial core plate 194 and the like.

Next, a method of manufacturing the stator 150 that comprises the core plates 270 and 370 will be described. First, a magnetic steel plate is punched to manufacture a plurality of original plates 280 and 380 for manufacturing a plurality of core plates. Subsequently, the plurality of original plates 280 and 380 is alternately layered. As a result, four pieces of tooth parts, yoke parts connected to the respective tooth parts, connecting portions that connect the respective tooth parts and the respective yoke parts, and two pieces of central partial cores are formed.

The four pieces of tooth parts comprise two pieces of tooth parts, each of which is formed by layering the tooth plate 272a and the tooth plate 372a, and two pieces two tooth parts, each of which is formed by layering the tooth plate 274a and the tooth plate 374a. In the following description, a tooth part formed when the tooth plate 272a and the tooth plate 372a are layered will be referred to as a tooth part 272a, and two pieces of tooth parts feinted when the tooth plate 274a and the tooth plate 374a are layered will be referred to as tooth parts 274a. The four pieces of yoke parts include two yoke parts, each of which is formed when the yoke plate 272b and the yoke plate 372b are layered, and two pieces of yoke parts which are formed when the yoke plate 274b and the yoke plate 374b are layered. In the following description, a yoke part formed when the yoke plate 272b and the yoke plate 372b arc layered will be referred to as a yoke part 372b, and two pieces of yoke parts formed when the yoke plate 274b and the yoke plate 374b are layered will be referred to as yoke parts 374b. A connecting portion that connects the tooth part 272a and the yoke part 372b will be referred to as a connecting portion 272c (that is fowled by layering the connecting portions 272c and 372c), and a connecting portion that connects the tooth part 274a and the yoke part 374b will be referred to as a connecting portion 274c (that is formed by layering the connecting portions 274c and 374c).

Subsequently, similar to the first embodiment, a step of forming the bobbin in the tooth parts 272a and 274a and a step of winding the coil wire are performed. Subsequently, each yoke part 372b is rotated with the connecting portion 272c as a center. As a result, the yoke part 372b is moved relative to the tooth part 272a, whereby the yoke part 372b contacts the tooth part 272a. Similarly, each yoke part 374b is rotated with the connecting portion 274c as a center. As a result, the yoke part 374b is moved relative to the tooth part 274a, whereby the yoke part 374b contacts the tooth part 274a. Consequently, six pieces of partial cores (corresponding to the partial cores 172 to 175 of FIG. 4) are formed. The six pieces of partial cores 172 to 175 of the third embodiment have different outer shapes from the partial cores 172 to 175 of the second embodiment. Further, the connecting portions 190, 194d 195d are deformed. As a result, the original plates 280 and 380 are deformed into the core plates 270 and 370, and the stator 150 (i.e., the cores 152 and 153) is manufactured. In this case, the yoke parts 372b to 374b extend toward the central tooth parts 174 and 175. A bending deformation is applied to the connecting portions 272c to 374c. Thus, when a metallographic structure of the connecting portions 272c to 374c is observed, a metallographic structure after application of bending deformation is observed.

shown in FIG. 9, the contact position 272d is different from the contact position 372d. Thus, the yoke plate 272b makes surface-contact with the yoke plate 372b and also makes surface-contact with the tooth plate 372a. For example, if the dimensional accuracy of the core plate 270 is not so high, there is a possibility that the yoke plate 272b and the tooth plate 272a are not appropriately in contact with each other. In this case, the yoke plate 272b and the tooth plate 272a are appropriately connected by the tooth plate 372a. Similarly, even in a case where the yoke plate 372b and the tooth plate 372a arc not appropriately in contact with each other due to the dimensional accuracy of the core plate 370, the yoke plate 372b and the tooth plate 372a are appropriately connected by the yoke plate 272b. Thus, the yoke plates 272b and 372b can appropriately make contact with the tooth plates 272a and 372a, respectively. Similarly, since the contact position 274d is different from the contact position 374d, the yoke plate 274b makes surface-contact with the yoke plate 374b and also makes surface-contact with the tooth plate 374a. Thus, the same advantages as the above can be obtained. According to this configuration, it is not necessary to strictly control the dimensional accuracy of the core plates 270 and 370.

Moreover; a motor portion that comprises the stator manufactured using the core plates 270 and 370 according to the third embodiment can provide the same advantages as those of the motor portion 40 according to the first embodiment.

(Modifications)

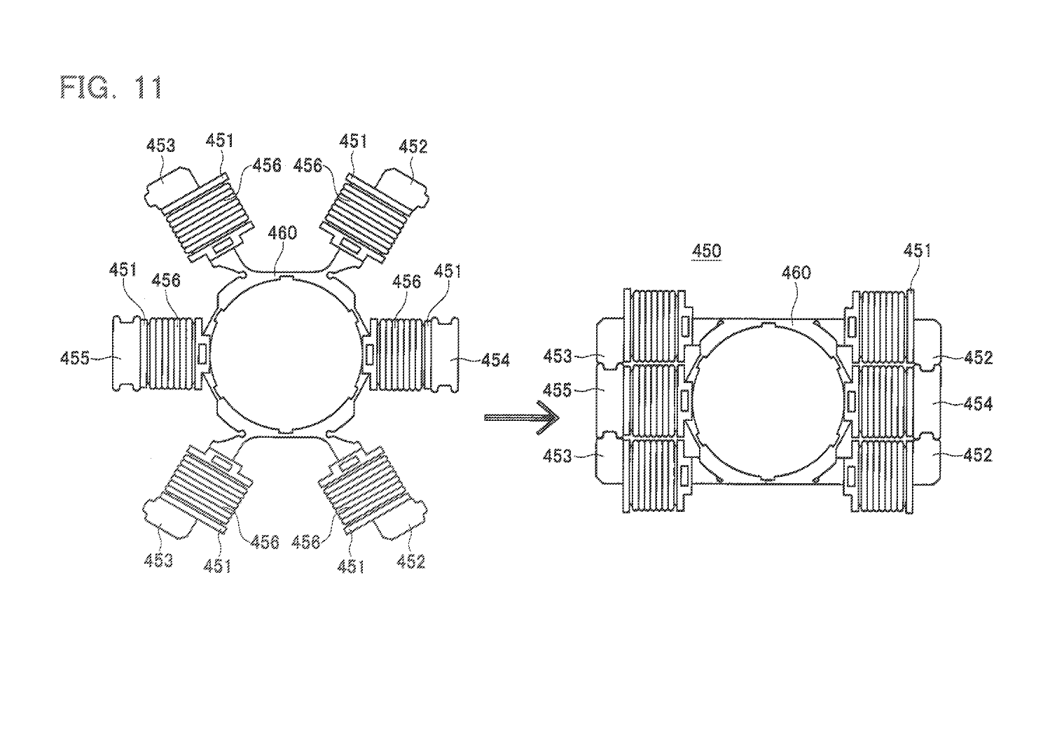

(1) As shown in FIG. 11, respective partial cores 452 to 455 may be connected to a ring-shaped member 460. When a stator 450 is manufactured, after a bobbin 451 is attached to the respective partial cores 452 to 455, and a coil wire 456 is wound around the bobbin 451, the respective partial cores 452 to 455 may be rotated relative to the ring-shaped member 460. In this manner, the stator 450 may be manufactured.

(2) In the respective embodiments described above, the two cores 52 and 53 or the like included in the stator 50 or the like have a symmetrical shape. However, the two cores 52 and 53 or the like may be not symmetrical. For example, a stator may comprise the core 52 and the core 153.

(3) In the second embodiment described above, the stator 150 that comprises four types of core plates 170a to 170d is manufactured. However, the number of types of core plates is not particularly limited. For example, a stator that comprises two types of core plates 170a and 170b may be manufactured. Alternatively, a stator may comprise at least five types of core plates including four types of core plates 170a to 170d and a type of core plate that is different from the four types of core plates 170a to 170d.

(4) In the respective embodiments described above, each partial core 72 or the like comprises the tooth part 72a or the like and the yoke part 72b or the like. However, for example, the side partial core 72 may comprise the tooth part 72a but not comprise the yoke part 72b, and the central partial core 74 may comprise the tooth part 74a and a yoke part that is longer than the yoke part 74b. In this case, the yoke part 74b may comprise a contacting surface that contacts the rear edge of the tooth part 72a. Alternatively, the central partial core 74 may comprise the tooth part 74a but not comprise the yoke part 74b, and the side partial core 72 may comprise the tooth part 72a and a yoke part that is longer than the yoke part 72b. In this case, the yoke part 72b may comprise a contacting surface that contacts the rear edge of the tooth part 74a.

(5) In the first embodiment described above, the central partial core 74 is connected to each of the adjacent two pieces of side partial cores 72 by the connecting portion 76. However, the central partial core 74 may be connected to only one side partial core 72 of the adjacent two pieces of side partial cores 72. Moreover, each of the two pieces of side partial cores 72 is connected to each of the opposing two pieces of side partial cores 73 by the connecting portion 60. However, the two pieces of side partial cores 72 may be not connected to the opposing two pieces of side partial cores 73. That is, the core 52 and the core 53 may be separate bodies. Alternatively, only one of the two pieces of side partial cores 72 may be connected to the opposing side partial cores 73.

1. A motor comprising:
a rotor; and
a stator comprising a first core and a second core opposing the first core across the rotor, wherein
the first core comprises three pieces of first partial cores and a first connecting portion connecting the first partial cores that are adjacent to one another,
each of the first partial cores comprises:
a tooth part disposed at a front edge portion of the first partial core, the tooth part extending toward the second core, and a front edge of the tooth part opposing an outer circumference of the rotor with a clearance in between; and
a contacting part disposed at a rear edge portion of the first partial core, the contacting part configured to contact the adjacent first partial core,
the first connecting portion connects edge portions of the teeth parts of the adjacent first partial cores included in the three pieces of the first partial cores,
in view of the stator along a rotation axis of the rotor, a thickness of the first connecting portion is thinner than a thickness of the first partial cores, and
the first core is formed such that a state of the contacting parts of the adjacent first partial cores changes from a separated state in which the contacting parts of the adjacent first partial cores are separated from each other to a contacting state in which the contacting parts of the adjacent first partial cores are contacting each other by a deformation of the first connecting portion.

2. The motor as in claim 1, wherein
the first core comprises a plurality of core plates layered in a direction of rotation of the rotor,
the plurality of core plates includes a first core plate with a first form and a second core plate with a second form that is different from the first form,
the first core plate comprises three pieces of first partial core plates configuring the three pieces of first partial cores,
the second core plate comprises three pieces of second partial core plates configuring the three pieces of first partial cores,
in view of the stator along the rotation axis of the rotor, a form of a first center partial core plate located at a center among the three pieces of first partial core plates is different from a form of a second center partial core plate located at a center among the three pieces of second partial core plates, and
in a state in which the first core plate is layered with the second core plate, a surface on one side of the first center partial core plate contacts surfaces on one side of the three pieces of second partial core plates.

3. The motor as in claim 1, wherein
the three pieces of first partial cores comprise a first center partial core and two pieces of first side partial cores,
each of the first side partial cores is adjacent to the first center partial core, each of the first side partial cores comprises:
a yoke part configured to contact a rear edge of the tooth part of the first side partial core and extend toward a rear edge of the first center partial core; and
a connecting part configured to connect the tooth part and the yoke part, in view of the stator along the rotation axis of the rotor, a thickness of the connecting parts is thinner than a thickness of the yoke parts and a thickness of the tooth parts, and
each of the first side partial cores is formed such that a state of the yoke part and the tooth part changes from a state in which the yoke part and the tooth part are disposed on a same straight line to a state in which the yoke part and the tooth part contact each other by a deformation of the connecting part.

4. The motor as in claim 3, wherein
the first core comprises a plurality of core plates layered in a direction of rotation of the rotor,
the plurality of core plates includes a third core plate with a third form and a fourth core plate with a fourth form that is different from the third form,
the third core plate comprises three pieces of third partial core plates configuring the three pieces of first partial cores,
the fourth core plate comprises three pieces of fourth partial core plates configuring ₜhe three pieces of first partial cores, and
in view of the stator along the rotation axis of the rotor, in the third partial core plate and the fourth partial core plate configuring the same first side partial core, a contact position between a partial plate configuring the yoke part and a partial plate configuring the tooth part of the third partial core plate is different from a contact position between a partial plate configuring the yoke part and a partial plate configuring the tooth part of the fourth partial core plate.

5. The motor as in claim 1, wherein
the three pieces of first partial cores comprise a first center partial core and two pieces of first side partial cores,
each of the first side partial cores is adjacent to the first center partial core,
the second core comprises three pieces of second partial cores, wherein:
the three pieces of second partial cores comprises a second center partial core and two pieces of second side partial cores,
each of the second side partial cores is adjacent to the second center partial core, and
each of the second side partial cores is opposed to the each of first side partial cores,
the stator further comprises a second connecting portion connecting one of, or both of the two pieces of first side partial cores of the first core and the corresponding second side partial core of the second core opposing the first side partial core connected to the second connecting portion, and
in view of the stator along the rotation axis of the rotor, a thickness of the second connecting portion is thinner than a thickness of the first partial cores and a thickness of the second partial cores.

6. The motor as h claim 1, wherein
the contacting part of each of the first partial cores contacts with other two pieces of the first partial cores.

7. The motor as in claim 1, wherein
the first core and the second core have a symmetrical form.

8. An electric pump comprising:
a motor as in claim 1;
an impeller configured to activate by the motor; and
a pump chamber configured to contain the impeller rotatably.
